(19) United States
(12) Patent Application Publication
(10) Pub. No.: US 2012/0040036 A1
(43) Pub. Date: Feb. 16, 2012

(54) FILM PRODUCING SYSTEM

(75) Inventor: SEI-PING LOUH, Tu-Cheng (TW)

(73) Assignee: HON HAI PRECISION INDUSTRY CO., LTD., Tu-Cheng (TW)

(21) Appl. No.: 12/913,791

(22) Filed: Oct. 28, 2010

(30) Foreign Application Priority Data
Aug. 16, 2010 (TW) 99127359

(51) Int. Cl. B29C 43/08

(52) U.S. Cl. 425/115

(57) ABSTRACT

A film producing system for producing optical film includes a glue dispenser, a conveyor including a flexible base, a compression molding device, and a light curing device. The glue dispenser is configured for receiving glue therein and dispensing the glue onto the flexible base. The flexible base is configured for carrying the glue dispensed thereon from the glue dispenser to the compression molding device. The compression molding apparatus configured for press molding the glue dispensed on the flexible base to a predetermined shape. The flexible base is configured for carrying the shaped glue from the compression molding device to the light curing device. The light curing device is configured for curing the glue shaped by the compression molding device. The compression molding device includes a rotating pressing roller and a fixed pressing blocking configured for shaping the glue on the flexible base to the predetermined shape.

### BACKGROUND

1. Technical Field

The present disclosure relates to a film producing system, and particularly, to an optical film producing system.

2. Description of Related Art

Many optical films, such as brightness enhancement films (BEF), typically include a base layer and a micro-structured layer formed on a surface of the base layer. The micro-structure-layer enhances the brightness of the emitted light.

Currently, the optical film is produced by a roll-to-roll manner. In detail, a glue layer is dispensed on a surface of a base layer; the base layer with the glue layer passes through a space between two rollers. One of the rollers includes a micro-structured pattern formed on the surface. The two rollers apply pressure on the base layer with the glue layer, and then the micro-structure pattern is printed on the surface of the glue layer. And then, the base layer with the glue layer is transported to a light curing device for curing the glue layer. However, it is difficult to manufacture the roller with micro-structured pattern, so the cost of the roller is increased, and thus the cost of the optical film increases as well.

What is needed therefore is film producing system addressing the above-mentioned problems.

### BRIEF DESCRIPTION OF THE DRAWINGS

The components of the drawings are not necessarily drawn to scale, the emphasis instead being placed upon clearly illustrating the principles of the embodiments of the film producing system. Moreover, in the drawings, like reference numerals designate corresponding parts throughout several views.

FIG. 1 is a schematic view of a film producing system according to an exemplary embodiment of the present disclosure.

FIG. 2 is an isometric view of the pressing block of the film producing system of FIG. 1.

### DETAILED DESCRIPTION

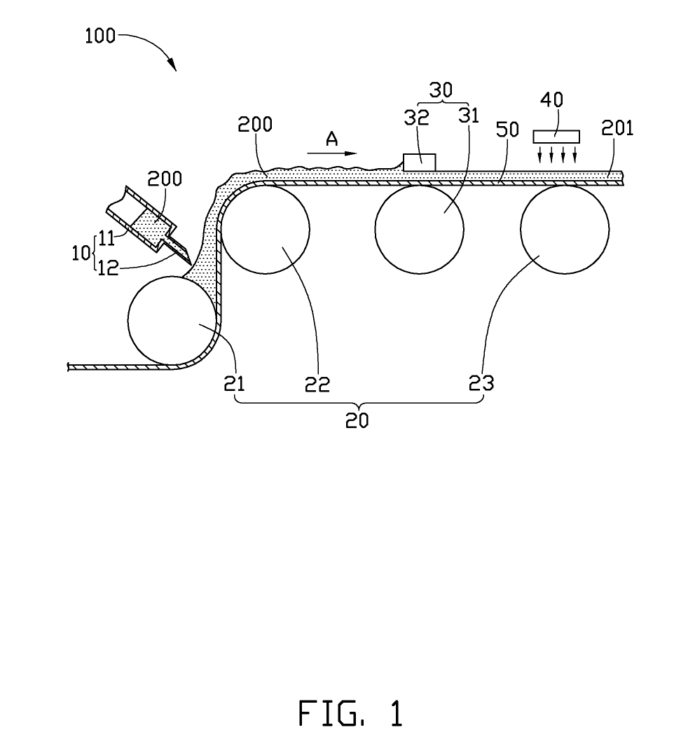

Referring to FIG. 1, a film producing system 100, according to an exemplary embodiment, is shown. The film producing system 100 includes a glue dispenser 10, a conveyor 20, a compression molding device 30, a light curing device 40, and a flexible base 50.

The glue dispenser 10 includes a container 11 and a dispensing nozzle 12 connected to the container 11. The container 11 receives glue 200 therein. The nozzle 12 is in communication with the container 11 and dispenses the glue 200 onto the surface of the flexible base 50. In this embodiment, the glue 200 is ultraviolet (UV) curable glue.

The conveyor 20 transports the flexible base 50 to reach the glue dispenser 10, the compression molding device 30 and the light curing device 40. The conveyor 20 includes a first roller 21, a second roller 22 and a third roller 23. The second roller 22 is between the first roller 21 and the third roller 23 and is spaced a predetermined distance from the first roller 21 and the third roller 23. The glue dispenser 10 is positioned adjacent the first roller 21, and the light curing device 40 is positioned adjacent to the third roller 23. The flexible base 50 passes through in sequence the first roller 21, the second roller 22 and the third roller 23. In this embodiment, the first roller 21 and the second roller 22 are located on two opposite sides of the flexible base 50, and the second roller 22 and the third roller 23 are located on a common side of the flexible base 50. In other embodiments, the first roller 21, the second roller 22, and the third roller 23 can be on a common side of the flexible base 50.

The first roller 21 and the second roller 22 are vertically aligned with each other, thus the flexible base 50 having a vertically oriented portion located between the first roller 21 and the second roller 22. The vertical distance between the first roller 21 and the second roller 22 can be adjusted. The second roller 22 and third roller 23 are spaced a horizontal predetermined distance from each other.

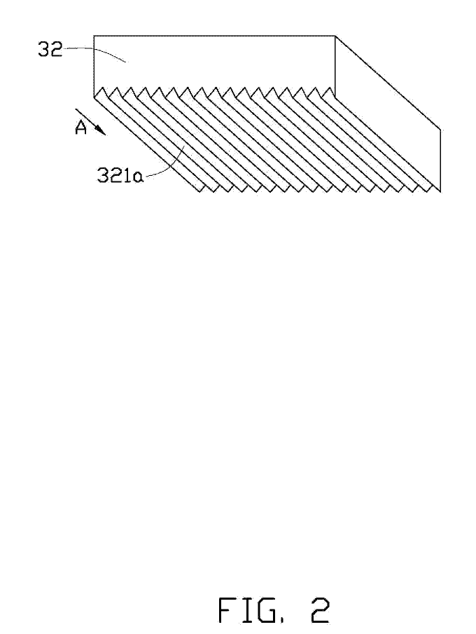

The compression molding device 30 includes pressing roller 31 and a pressing block 32 spaced a predetermined distance from the pressing roller 31. The pressing roller 31 and the pressing block 32 are correspondingly positioned at two opposite sides of the flexible base 50. The pressing roller 31 and the pressing block 32 press the flexible base 50 with the glue 200 therebetween. Referring to FIG. 2, the pressing block 32 is substantially cuboid. A micro-structure pattern 321 is formed on a surface of the pressing block 32 opposite to the pressing roller 31. In this embodiment, the micro-structure pattern 321 is comprised of a number of parallel grooves 321a. A lengthwise direction of each of the grooves is substantially parallel to the movement direction A of the flexible base 50.

The light curing device 40 solidifies the glue on the flexible base 50. In this embodiment, the light curing device 40 is an ultraviolet radiation source.

The flexible base 50 carries the glue 200. In this embodiment, the flexible base 50 is a thin film made from polyethylene terephthalate (PET).

The film producing system 100 produces optical film. In use, the glue 200 is dispensed in a gap between the first roller 21 and the flexible base 50. In this embodiment, the glue dispenser 10 continuously dispenses glue 200 in the gap to keep a substantial amount of glue in the gap 200, thus the glue 200 can be uniformly dispensed on the flexible base 50. The first roller 21, the second roller 22, and the third roller 23 are rotated at a predetermined speed for transporting the flexible base 50. The glue 200 can be automatically dispensed on a surface of the flexible base 50 when the flexible base 50 is transported from the first roller 21 to the second roller 22, and the glue 200 can be further uniformly dispensed on the surface of the flexible base 50 by gravity. The glue 200 is molded to a predetermined shape under the pressure of the compression molding device 30 when the flexible base 50 is transported through the compression molding device 30. The micro-structure pattern 321 prints a similar micro-structure pattern (not labeled) on the surface of the glue 200 during the process of pressing the flexible base 50. The glue 200 with the printed micro-structure pattern is solidified by the light curing device 40 when the flexible base 50 is transported to the light curing device 40. Thereby, a micro-structure layer 201 is formed.

The viscosity of the glue 200 and the velocity of the flexible base 50 can be adjusted to ensure a proper dispensing thickness and the uniformity of glue 200 on the flexible base 50, and a certain deformation resistance of the glue 200 after molding. In this embodiment, the viscosity of the glue 200 is at a range of about 0.2-1.5 Pa·s, the velocity of the flexible base 50 is at a range of about 10-20 meters/min.

In other embodiments, the first roller 21 and second roller 22 also can be spaced a horizontal distance from each other, thus the flexible base 50 between the first roller 21 and the second roller 22 is tilted at an angle relative to the vertical direction, and thus the requirement of the viscosity of the glue 200 can be reduced. In addition, the molded glue 200 should be solidified immediately to avoid the deformation of the glue 200 by gravity, at the same time the intensity of the ultraviolet radiation can be increased for enhancing the solidifying speed of the glue 200.

The micro-structure layer 201 and the flexible base 50 can cooperatively form an optical film, or the micro-structure layer 201 itself can form an optical film after being separated from the flexible base 50.

It is easy and inexpensive to manufacture the pressing block 32, therefore, the cost of the film producing system 100 and the optical film produced by the film producing system 100 is reduced.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A film producing system for producing optical film, comprising
a glue dispenser,
a conveyor comprising a flexible base,
a compression molding device, and
a light curing device,
wherein the glue dispenser is configured for receiving glue therein and dispensing the glue onto the flexible base, the flexible base is configured for carrying the glue dispensed thereon from the glue dispenser to the compression molding device, the compression molding apparatus configured for press molding the glue dispensed on the flexible base to a predetermined shape, the flexible base is configured for carrying the shaped glue from the compression molding device to the light curing device, the light curing device is configured for curing the glue shaped by the compression molding device, the compression molding device comprises a rotating pressing roller and a fixed pressing blocking, the pressing block is configured for shaping the glue on the flexible base to the predetermined shape.

2. The film producing system of claim 1, wherein the glue dispenser comprises a container and a dispensing nozzle connected to the container, the container is configured for containing the glue therein, and the nozzle is in communication with the container and is configured for dispensing the glue to the flexible base.

3. The film producing system of claim 1, wherein the conveyor comprises a first roller, a second roller and a third roller, the second roller is between the first roller and the third roller and is spaced from the first roller and the third roller, the glue dispenser is positioned adjacent to the first roller, and the light curing device is positioned adjacent to the third roller.

4. The film producing system of claim 3, wherein the first roller and the second roller are located on opposite sides of the flexible base, and the second roller and the third roller are located on a common side of the flexible base.

5. The film producing system of claim 3, wherein the first roller and the second roller are vertically aligned with each other, the flexible base having a vertically oriented portion located between the first roller and the second roller.

6. The film producing system of claim 1, wherein the pressing block comprises a micro-structure pattern formed on a surface thereof facing the pressing roller.

7. The film producing system of claim 6, wherein the micro-structure pattern comprises a plurality of parallel grooves, and a lengthwise direction of each of the grooves is substantially parallel to a movement direction of the flexible base between the second roller and the third roller.

8. The film producing system of claim 1, wherein the light curing device is an ultraviolet light source, and the glue is ultraviolet curable glue.

9. The film producing system of claim 1, wherein the flexible base is made from polyethylene terephthalate.
